(19) United States
(12) Patent Application Publication
(10) Pub. No.: US 2024/0393121 A1
(43) Pub. Date: Nov. 28, 2024

(54) METHOD FOR RECOMMENDING ENERGY EFFICIENT ROUTE FOR V2V ENERGY EXCHANGE AND SYSTEM THEREOF

(71) Applicant: Daimler Truck AG, Leinfelden Echterdingen (DE)

(72) Inventors: SAURABH DATTUKUMAR SHAH, Bangalore (IN); ADITHYA MAHABALESHWARA BHAT, Bengaluru (IN); AYUSH CHOUBEY, Bangalore (IN); SHILPA PRASAD PULICKAL, Bangalore (IN)

(21) Appl. No.: 18/673,476

(22) Filed: May 24, 2024

(30) Foreign Application Priority Data
May 26, 2023 (IN) 202341036532

(51) Int. Cl. G01C 21/34; G01C 21/36

(52) U.S. Cl. CPC G01C 21/3469; G01C 21/3415; G01C 21/3679; G01C 21/3697

(57) ABSTRACT

The present invention describes a method (700) for recommending energy efficient routes to vehicles, for V2V energy exchange. The method recites identifying (702) at least one energy consumer vehicle and one or more energy supplier vehicles, among a plurality of vehicles and selecting (704), for each of the identified at least one energy consumer vehicle, at least one corresponding energy supplier vehicle from the identified one or more energy supplier vehicles. The method further recites calculating (712) an updated optimal route for the selected at least one energy supplier vehicle and for the at least one energy consumer vehicle. The method further recites recommending (714) the updated optimal route for the at least one energy supplier vehicle and the at least one energy consumer vehicle for V2V energy exchange, indicating at least one energy exchange location and duration of energy exchange.

### PREAMBLE TO THE DESCRIPTION

The following specification particularly describes the invention and the manner in which it is to be performed.

### DESCRIPTION OF THE INVENTION

### Technical Field

The present invention generally relates to a method and a system for recommending energy efficient routes to vehicles using V2V energy exchange.

### BACKGROUND

The following description includes information that may be useful in understanding the present invention. It is not an admission that any of the information provided herein is prior art or relevant to the presently claimed invention, or that any publication specifically or implicitly referenced is prior art.

Electric vehicle(s) (EVs) are currently experiencing a growing demand due to growing lack of fossil fuels and due to carbon dioxide emissions from exhaust in conventional internal engine vehicles. The EVs purely utilize an electric driving motor which runs on electric energy stored in the battery to power an electric vehicle. Further, electric vehicles have become increasingly popular due to their environmental sustainability and cost-effectiveness.

Fleets around the world are increasingly turning to electric vehicles as a means of transportation. While electric vehicles are an environmentally sustainable option, they are limited by their low range, which can lead to range anxiety among drivers. This has resulted in fleet owners being forced to rely on external charging points to keep their vehicles powered.

External charging points are typically located at charging stations and are designed to allow electric vehicles to recharge their batteries. However, external charging during the day can be an expensive option that fleet owners want to avoid as it increases operating costs and negatively impacts delivery schedules.

Additionally, the availability of charging stations for EVs is a critical factor for fleet owners when planning their trips. Knowing in advance the location and availability of charging stations is essential to ensure that the vehicle can be charged in a timely manner without causing any delays in delivery schedules. Additionally, even when charging points are available there can be significant waiting time due to high demand or limited charging capacity. This can result in long waiting times for fleet owner operators, which reduces overall fleet efficiency and productivity.

The conventional process of identifying charging stations and charging the EVs from the charging stations increases operating costs, negatively impacts delivery schedules, and reduce overall fleet efficiency and productivity. Further, the conventional charging process negatively impacts trip planning in the absence of lack of comprehensive charging infrastructure network in a route.

Thus, there is a need for a system that enables the EV user to plan a trip efficiently and effectively without relying only on the external charging in order to optimize the route and charging schedules for EV.

### SUMMARY OF THE DISCLOSURE

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an aspect, the present disclosure may recite a method for recommending energy efficient routes to vehicles, for V2V energy exchange. The method includes identifying at least one energy consumer vehicle and one or more energy supplier vehicles, among a plurality of vehicles, based on route information of the plurality of vehicles and energy consumption associated with the route information. The method further includes selecting, for each of the identified at least one energy consumer vehicle, at least one corresponding energy supplier vehicle from the identified one or more energy supplier vehicles based on at least one proximity location. The proximity location corresponds to a location at which routes of the selected energy consumer vehicle and the selected at least one energy supplier vehicle either interact or are in close proximity to each other. The method further includes identifying a plurality of energy exchange locations based on the proximity locations, extracting the route information and the energy consumption associated with the route information of the selected at least one energy supplier vehicle and the at least one energy consumer vehicle, and identifying an optimal route, from the extracted route information, for the at least one energy consumer vehicle and the selected at least one energy supplier vehicle. The method further includes calculating an updated optimal route for the selected at least one energy supplier vehicle and for the at least one energy consumer vehicle based on at least one of the identified optimal route, the plurality of energy exchange locations, the extracted route information and energy consumption associated with the extracted route information, and one or more constraints. Finally, the method includes recommending the updated optimal route for the at least one energy supplier vehicle and the at least one energy consumer vehicle for V2V energy exchange, indicating at least one energy exchange location from the identified plurality of energy exchange locations and duration of energy exchange.

In another aspect, the present disclosure recites a method for identifying at least one energy consumer vehicle that includes receiving the route information of each of the plurality of vehicles and predicting energy consumption of each of the plurality of vehicles based on the route information. The energy consumption of each of the plurality of vehicles is predicted at multiple time instances during a travel. The method further includes generating the optimal route for each of the plurality of vehicles based on the predicted energy consumption and categorizing the plurality of vehicles as energy consumer vehicle based on energy consumption on the generated optimal route.

In another aspect, the present disclosure recites a method for selecting the at least one energy supplier vehicle that includes receiving the route information of the one or more energy supplier vehicles. The method further includes identifying at least one energy supplier vehicle from the one or more energy supplier vehicles based on the received route information and at least one of waiting time, delivery information, minimum detour, charging rate of the one or more energy supplier vehicles. The charging rate is energy exchange rate of the one or more energy supplier vehicles.

In another aspect, the present disclosure recites that the updated optimal route for the selected at least one energy supplier vehicle and for the energy consumer vehicle include energy exchange information. The energy exchange information includes amount of energy to be exchanged between the selected at least one energy supplier vehicle and energy consumer vehicle, time for the energy exchange, and the energy exchange location.

In another aspect, the present disclosure recites a method includes identifying, in real-time, a deviation in the updated optimal route of the at least one of the energy consumer vehicle and the selected at least one energy supplier vehicle. The method further includes resequencing the updated optimal route for the energy consumer vehicle, in response to identifying the deviation in the updated optimal route.

In an aspect, the present disclosure recites system for recommending energy efficient routes to vehicles, for V2V energy exchange. The system comprises one or more processing unit configured to identify at least one energy consumer vehicle and one or more energy supplier vehicles, among a plurality of vehicles, based on route information of the plurality of vehicles and energy consumption associated with the route information. The one or more processing unit is further configured to select, for each of the identified at least one energy consumer vehicle, at least one corresponding energy supplier vehicle from the identified one or more energy supplier vehicles based on at least one proximity location. The proximity location corresponds to a location at which routes of the selected at least one energy consumer vehicle and the selected energy supplier vehicle either interact or are in close proximity to each other. The one or more processing unit is further configured to identify a plurality of energy exchange locations based on the proximity locations. The one or more processing unit is further configured to extract the route information and the energy consumption associated with the route information of the selected at least one energy supplier vehicle and the at least one energy consumer vehicle and identify an optimal route, from the extracted route information, for the at least one energy consumer vehicle and the selected at least one energy supplier vehicle. The one or more processing unit is further configured to calculate an updated optimal route for the at least one energy consumer vehicle and the selected at least one energy supplier vehicle based on at least one of the identified optimal route, the plurality of energy exchange locations, the extracted route information and energy consumption associated with the extracted route information, and one or more constraints. Furthermore, the one or more processing unit is further configured to recommend the updated optimal route for the at least one energy supplier vehicle and the at least one energy consumer vehicle for V2V energy exchange, indicating at least one energy exchange location from the identified plurality of energy exchange locations and duration of energy exchange.

In another aspect, the present disclosure recites one or more processing unit to identify at least one energy consumer vehicle. The system further comprises a receiving unit configured to receive the route information of each of the plurality of vehicles. The one more processing unit is further configured to predict energy consumption of each of the plurality of vehicles based on the route information, wherein the energy consumption of each of the plurality of vehicles is predicted at multiple time instances during a travel. The one or more processing unit is further configured to generate the optimal route for each of the plurality of vehicles based on the predicted energy consumption and categorize the plurality of vehicles as energy consumer vehicle based on energy consumption on the generated optimal route.

In another aspect, the present disclosure recites one or more processing unit to select the at least one energy supplier vehicle. The system further comprises a receiving unit configured to receive the route information of the one or more energy supplier vehicles. The one or more processing unit is further configured to identifying at least one energy supplier vehicle from the one or more energy supplier vehicles based on the received route information and at least one of waiting time, delivery information, minimum detour, and charging rate of the one or more energy supplier vehicles. The charging rate is energy exchange rate of the one or more energy supplier vehicles. The one or more processing unit is further configured to suggest a start time for the at least one energy consumer vehicle and the selected at least one energy supplier vehicle to minimize the waiting time and energy consumption in order to meet delivery schedules for the at least one energy consumer vehicle and the selected at least one energy supplier vehicle.

In another aspect, the present disclosure discloses the updated optimal route for the selected at least one energy supplier vehicle and for the energy consumer vehicle to include energy exchange information. The energy exchange information includes amount of energy to be exchanged between the selected at least one energy supplier vehicle and energy consumer vehicle, time for energy exchange, and the energy exchange location.

In another aspect, the present disclosure recites one or more processing unit configured to identify, in real-time, a deviation in the updated optimal route of the at least one of the energy consumer vehicle and the selected at least one energy supplier vehicle. The one or more processing unit is configured to resequence the updated optimal route for the energy consumer vehicle, in response to identifying the deviation in the updated optimal route.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an environment architecture for a system, in accordance with an embodiment of the present disclosure.

FIG. 2 illustrates by way of a block diagram a system that recommends energy efficient routes to vehicles, in accordance with an embodiment of the present disclosure.

FIG. 3 illustrates an exemplary embodiment of the identification of the plurality of energy exchange locations and selection of the energy supplier vehicle for the energy consumer vehicle, in accordance with an embodiment of the present disclosure.

FIG. 4 illustrates by way of a block diagram of a system for identifying energy supplier vehicles and energy consumer vehicle, in accordance with an embodiment of the present disclosure.

FIG. 5 illustrates by way of block diagram a system for selection of energy supplier vehicle and generation of the updated optimal routes, in accordance with an embodiment of the present disclosure.

FIG. 6 illustrates an exemplary embodiment of the updated optimal route, in accordance with an embodiment of the present disclosure.

FIG. 7 a flow diagram illustrating a method for recommending energy efficient routes to vehicles, for V2V energy exchange, in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein.

Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The phrase “vehicle” or “electric vehicle” are used interchangeably throughout the disclosure. The electric vehicle refers to Battery Electric Vehicles (BEVs). These vehicles are powered entirely by batteries that store electricity, which is used to power the electric motor that drives the wheels. The electric vehicle may not have a gasoline engine and may not use any fossil fuels. The electric vehicle may be charged by plugging the electric vehicle into an electrical outlet or charging station. The electric vehicle may be a car, truck, semi-truck, motorcycle, plane, train, moped, scooter, or other type of transportation. Further, the electric vehicle may use many types of powertrains. For example, the electric vehicle may be a plug-in electric vehicle, a plug-in hybrid electric vehicle, a hybrid electric vehicle, or a fuel cell vehicle.

Disclosed herein is a system for recommending energy efficient routes to vehicles, for V2V energy exchange. The system may identify at least one energy consumer vehicle and one or more energy supplier vehicles, among a plurality of vehicles, based on route information of the plurality of vehicles and energy consumption associated with the route information. To identify at least one energy supplier vehicle for each of the identified at least one consumer vehicle, the system may select, for each of the identified at least one energy consumer vehicle, at least one corresponding energy supplier vehicle from the identified one or more energy supplier vehicles based on at least one proximity location. The proximity location corresponds to a location at which routes of the selected energy consumer vehicle and the selected energy supplier vehicle either interact or are in close proximity to each other. After that the system may identify a plurality of energy exchange locations based on the proximity locations. Then the system may extract the route information and the energy consumption associated with the route information of the selected at least one energy supplier vehicle and the at least one energy consumer vehicle, and identify an optimal route, from the extracted route information, for the selected at least one energy consumer vehicle and the at least one energy supplier vehicle. For identifying updated optimal route, the system may calculate an updated optimal route for the selected at least one energy supplier vehicle and for the at least one energy consumer vehicle based on at least one of the identified optimal route, the plurality of energy exchange locations, the extracted route information and energy consumption associated with the extracted route information, and one or more constraints. Finally, the system may recommend the updated optimal route for the at least one energy supplier vehicle and the at least one energy consumer vehicle with V2V energy exchange, indicating at least one energy exchange location from the identified plurality of energy exchange locations and duration of energy exchange.

Turning now to the drawings, the detailed description set forth below in connection with the appended drawings is intended as a description of various configurations and is not intended to represent the only configurations in which the concepts described herein may be practiced. The detailed description includes specific details for the purpose of providing a thorough understanding of various concepts with like numerals denote like components throughout the several views. However, it will be apparent to those skilled in the art that these concepts may be practiced without these specific details.

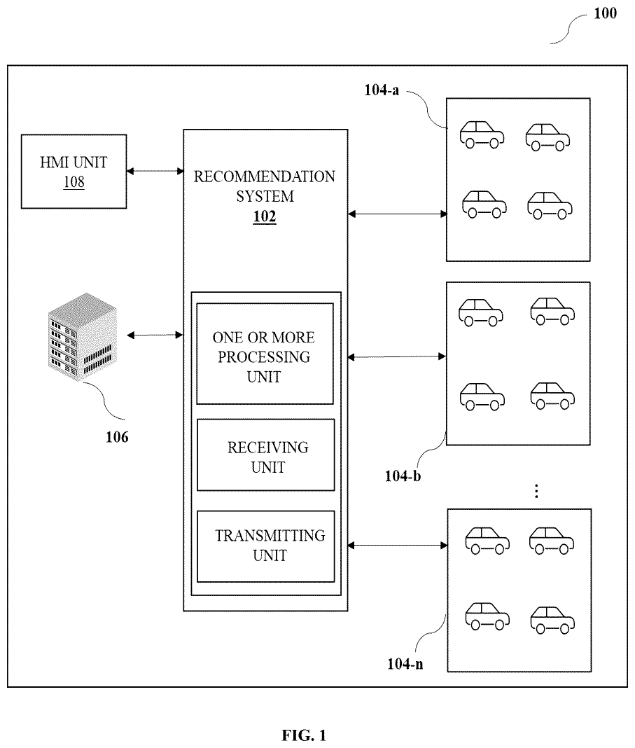

FIG. 1 illustrates an environment architecture for implementing a system that recommend energy efficient routes to vehicles, for vehicle to vehicle (V2V) energy exchange, in accordance with an embodiment of the present disclosure. The environment architecture 100 may constitute a system 102, one or more set of vehicles 104, a server 106, and a human machine interface (HMI) unit 108. All the constituent elements of the environment architecture 100 illustrated in FIG. 1 are essential constituent elements, however the environment architecture 100 may be implemented by more constituent elements than the constituent elements illustrated in FIG. 1. However, the same are not explained for the sake of brevity. The system 102 may communicate with all the constituent elements of the environment architecture 100. The system 102 may communicate with at least one set of vehicles 104, a server 106, and the HMI unit 108 via wireless/wired communication network.

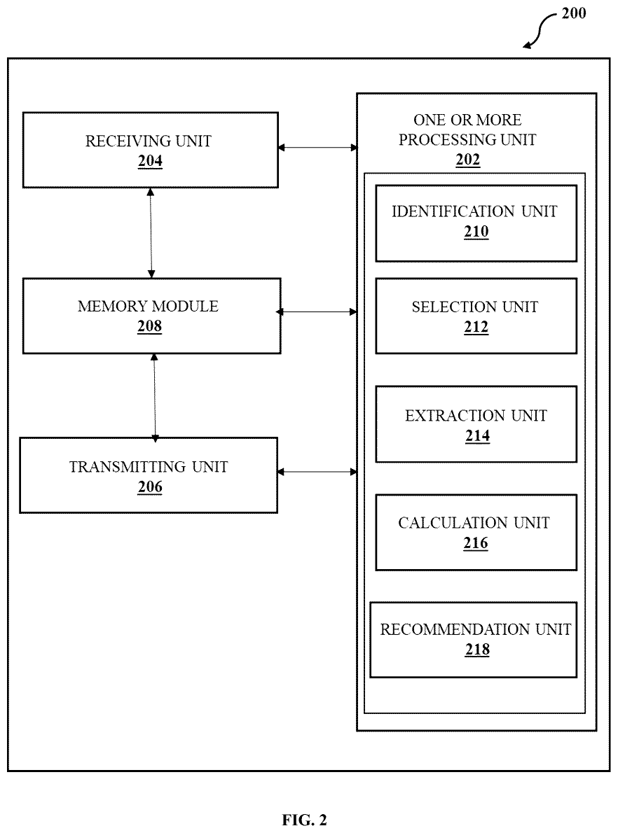

In an embodiment, the system 102 may comprise one or more processing unit, a receiving unit, and a transmitting unit. Further, the constituted elements of the system 102 may communicate with all other constituent elements of the environment architecture 100 in order to provide energy efficient routes for electric vehicles by identifying an optimal parking location such that the vehicle-to-vehicle charging is implemented at the optimal parking location/energy exchange location. The detailed functioning of the system 102, in conjunction with other elements disclosed in FIG. 1, is further explained in FIG. 2 in forthcoming paragraphs of the present disclosure.

In an embodiment, the system 102 may be implemented in a variety of computing systems, such as a laptop computer, a desktop computer, a Personal Computer (PC), a notebook, a smartphone, a tablet, e-book readers, a server, a network server, a cloud-based server and the like. Further, in an embodiment, the system 102 may be a cloud-based server.

In addition, the one or more set of electric vehicles 104 are also in communication with the system 102 in order to receive recommendation of energy efficient route, for V2V energy exchange. In accordance with the present disclosure, the one or more set of vehicles 104 may include a first set of vehicles 104-a, a second set of vehicles 104-b, and so on. The set of vehicles 104-a to 104-n may be fleet vehicles or vehicles other than the fleet vehicles.

The fleet vehicles may be referred to a group of vehicles that are owned or leased by a business, government agency, or other organization and are used for specific purposes such as transportation, delivery, or service. The fleet vehicles may be used for a variety of purposes, such as employee transportation, product delivery, or service provision. For example, a company may have a fleet of delivery trucks to transport goods to their customers, or a taxi company may have a fleet of cars to provide transportation services to their clients.

In an exemplary embodiment of the present disclosure, fleet vehicles may be electric vehicles which is used by an individual for delivering goods to multiple location and can be of different types and sizes, depending on the needs of the organization. Each set of vehicles (same as the fleet vehicles) may be associated with different owner. For example, the first set of vehicles 104-a may be associated with a first owner, the second set of the vehicles 104-b may be associated with a second owner, and so on.

Further, the server 106 may be configured to communicate with the system 102 in order to provide different information to the system 102. In particular, the server may be connected to an application programming interface (API) to provide different information to the system 102. The API may be used to enable software applications to interact with other software applications or services. API use standardized protocols and data formats to enable communication between applications, such as HTTP or REST. By the functioning of the API, the API may provide different information to the system 102.

The HMI unit 108 may be a user interface or dashboard that connects a person to a machine, system, or device in the vehicle. In an embodiment, the HMI unit 108 may be an integral part of the each of the one or more set of vehicles 104. In an embodiment, the HMI unit 108 may be embedded within a user device associated with the driver of the vehicle. The user device may include, but is not limited to, smartphones, tablets, computer monitor, touch screen devices, and so on. In an embodiment, the HMI unit 108 may include a display unit, a speaker, a microphone and so on. In an embodiment, the display unit may be used for displaying the optimal route along with an energy exchange location. In an embodiment, the speaker may be used for providing instruction to the driver relating to the optimal route. In an embodiment, the microphones could be used by drivers to provide voice commands relating to the plurality of locations.

Moving to FIG. 2 that illustrates a system 200 (same as the system 102 of FIG. 1) for recommending energy efficient routes to vehicles, for V2V energy exchange, in accordance with an embodiment of the present disclosure. It must be understood to a person skilled in art that architecture may also be implemented in various environments, other than as shown in FIG. 2.

According to an embodiment of the present disclosure, the system 200 may be constituted by one or more processing unit 202, a receiving unit 204, a transmitting unit 206, and a memory module 208. All the constituent elements of the system 200 illustrated in FIG. 2 are essential constituent elements, but the system 200 may also be implemented by more constituent elements than the constituent elements illustrated in FIG. 2, however the same are not explained for the sake of brevity. All the constituent elements of the system 200 may communicate with each other via wireless/wired communication network.

Further, the one or more processing unit 202 are constituted by at least an identification unit 210, a selection unit 212, an extraction unit 214, a calculation unit 216, and a recommendation unit 218. All the constituent elements included in the one or more processing unit 202 illustrated in FIG. 2 are essential constituent elements, but the one or more processing unit 202 may be implemented by more constituent elements than the constituent elements illustrated in FIG. 2. However, the same are not explained for the sake of brevity. All the constituent elements of the one or more processing unit 202 may communicate with each other via wireless/wired communication network.

In a non-limiting embodiment of the present disclosure, the identification unit 210 may be configured to identify at least one energy consumer vehicle and one or more energy supplier vehicles, among a plurality of vehicles, based on route information of the plurality of vehicles and energy consumption associated with the route information.

In particular, the receiving unit 204 may be configured to receive a request from a plurality of vehicles for exchanging electric energy with another electric vehicles. The receiving unit 204 may be configured to receive plurality of locations of the plurality of vehicles along with the request. The user of the plurality of vehicles may transmit the plurality of locations via using the HMI (such as the HMI 108 of FIG. 1). The plurality of locations may include a current location, a destination location, and one or more intermediate stop locations. The current location may be a location where a vehicle is located presently. The destination location may be an end point where the vehicle may stop. The one or more intermediate stop locations of the vehicle may be locations between the current location and the destination location. The electric vehicle may stop at the one or more intermediate stop locations either to deliver or pick-up goods.

For example, electric vehicle either may require less energy or more energy than the present vehicle energy to travel a longer distance for transportation of goods from current location to destination location via the intermediate locations. If the electric vehicle may require more energy, then the electric vehicle may recharge a battery of the electric vehicle from another vehicle during the transportation of goods. If the electric vehicle may require less energy, then the electric vehicle may provide excess energy to another vehicle during the transportation of goods. Considering these two situations, electric vehicles provide the plurality of locations and the request for exchange of energy.

In an alternative embodiment, the system 200 may transmit a request to the plurality of vehicles by using the transmitting unit 206 in order to receive the plurality of locations from each of the plurality of vehicles.

Simultaneously, the plurality of vehicles may provide delivery information and vehicle information. The vehicle information may include, not limited to, initial State of Charge (SOC) of battery, characteristics of the vehicle and so on. The delivery information may include, not limited to, information on the weight of goods that is to be delivered and picked up by the vehicle at the plurality of locations, at respective predefined time. Further, the delivery information may include average loading/unloading time of the goods at each of the plurality of locations and a time at which the vehicle starts its operation of delivery and pickup of the goods.

The SOC of the battery is a measurement of the amount of energy available in the battery at a specific point in time. In an embodiment, the initial SOC of battery of the vehicle may be received dynamically in real-time when generating an optimal route. In an embodiment, the specific point in time when the initial SOC is measured may be time instant before the vehicle starts journey for the delivery. The characteristics of the vehicle may include, but are not limited to, dimension of the vehicle, capacity of the vehicle, weight of the vehicle, speed of the vehicle, real-time location of the vehicle and so on.

The receiving unit 204 may be, for example, a receiver that may include an antenna, an antenna array, an input interface, a pin, a circuit, or the like.

After receiving the plurality of locations, the system 200 may transmit a request to the server (such as the server 106 of FIG. 1) via the transmitting unit 206 to provide route conditions of the plurality of vehicles and velocity profile of the plurality of vehicles based on their plurality of locations and the vehicle information. The route information corresponding to the plurality of location received from the server via the receiving unit 204 may include real-time information about traffic conditions, including traffic congestion, accidents, and construction work and information about the current state of roads, including weather conditions, road closures, a set of routes based on the plurality of locations, and so forth. The set of routes based on the plurality of locations refers to a collection of possible travel routes that connect plurality of locations multiple ways. The route information of each of the plurality of vehicles includes a plurality of locations and route conditions.

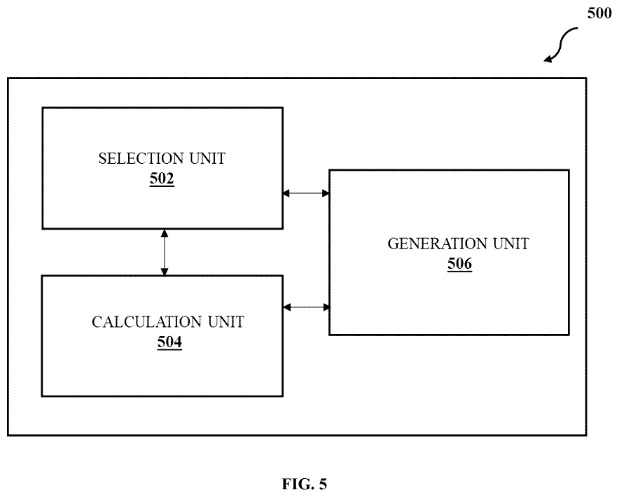

After receiving the route information and vehicle information of the plurality of vehicles from the receiving unit 204, the identification unit 210 may identify energy consumer vehicles and energy supplier vehicles among the plurality of vehicles based on the route information of the plurality of vehicles and energy consumption associated with the route information. The identification of the energy consumer vehicles and energy supplier vehicles by the identification unit 210 is further explained in FIG. 5 in forthcoming paragraphs. However, a person skilled in the art will appreciate that the energy consumer vehicle may be an electric vehicle that may require more energy than the energy present in the electric vehicle in order to perform transportation of goods, whereas the energy supplier vehicle may be an electric vehicle that may require less energy than the energy present in the electric vehicle in order to perform transportation of goods.

After the identification of the energy consumer vehicles and energy supplier vehicles, the memory module 208 may store, for each of the energy consumer vehicles and the energy supplier vehicles, the identification information along with the route information.

The memory module 208 may be, for example, conventional magnetic disks, optical disks such as magnetic tape storage, magneto-optical (MO) storage media, solid state disks, flash memory-based devices, or any other type of non-volatile storage devices suitable for storing large volumes of data. The memory module 208 may also be combinations of such devices. In the case of disk storage media, the memory module 208 may be organized into one or more volumes of redundant array of inexpensive disks (RAID).

In a non-limiting embodiment of the present disclosure, after the identification of the energy consumer vehicles and energy supplier vehicles, the selection unit 212 may be configured to select, for each of the identified at least one energy consumer vehicle, at least one corresponding energy supplier vehicle from the identified one or more energy supplier vehicles based on at least one proximity location, wherein the proximity location corresponds to a location at which routes of the selected energy consumer vehicle and the selected at least one energy supplier vehicle either interact or are in close proximity to each other.

Particularly, the selection unit 212 may perform the below process for each of the identified energy consumer vehicles.

Firstly, the selection unit 212 may extract from the memory module 208 the plurality of the locations from the route information of the identified energy consumer vehicle. After the extraction of the plurality of locations, the selection unit 212 may determine one or more location pairs based on the plurality of locations. The one or more location pairs are determined by pairing each location with other location from the plurality of locations. For example, plurality of locations may include a current location, a destination location, and two intermediate stop locations. The current location will be paired with the destination location via the intermediate locations. During the paring of the location, every location is paired with every other location from the plurality of locations. For N number of locations, N*N−1 combinations are possible for the one or more location pairs. In an embodiment, for the four locations possible number of the one or more location pairs is twelve.

After the identification of the location pairs for the identified energy consumer vehicle, the selection unit 212 may extract from the memory module 208 the plurality of the locations from the route information of the identified energy supplier vehicles and may determine the location pairs for each of the energy consumer vehicles based on the plurality of locations of the energy consumer vehicles. The selection unit may use a technique to determine location pairs based on the plurality of locations. The technique may be, not limited to, Brute force technique, Clustering technique, Graph-based technique, and so forth.

Finally, the selection unit 212 may select the energy supplier electric vehicles for the energy consumer electric vehicle. The selection unit 212 may use a technique to compare a routes of location pairs of the plurality of locations of the energy consumer vehicle with routes of location pairs of the plurality of locations of all the other energy supplier vehicles. After the comparison, the selection unit 212 may identify a list of all the energy supplier electric vehicles whose location pairs routes may be in close proximity with or may intersect location pairs routes of the energy consumer vehicle. The technique may be, not limited to, Spatial Join technique, Geometric technique, Network Analysis technique, clustering technique, and so forth.

In an alternative embodiment, the selection unit 212 may extract from the memory module 208 the set of routes of the identified energy consumer vehicle and the identified energy supplier vehicles. After the extraction, the selection unit 212 may select a list of all the energy supplier vehicles whose routes may be in close proximity with or may intersect with routes of the energy consumer vehicle.

In a non-limiting embodiment of the present disclosure, identification unit 210 may be configured to identify a plurality of energy exchange locations based on the proximity locations.

In particular, after the selection of the energy supplier vehicles as described above, the selection unit 212 may identify routes of the energy consumer vehicle which are intersected or in close proximity with the routes of the energy supplier electric vehicles. After the identification of the routes, the extraction unit may provide the list to the identification unit 210. After receiving the list, the identification unit 210 may identify coordinates of proximity locations at which the list of routes intersect or in close proximity with the routes of the energy supplier electric vehicles. The identification unit 210 may use one or more known techniques to identify the coordinates. The technique may be, not limited to, geocoding technique, Geographic Information Systems technique, reverse geocoding, and so forth.

After identification of the coordinates, the system 200 may provide by using the transmitting unit 206 the proximity locations and coordinates of the proximity locations to the server 106. The server 106 may identify parking locations that are close to the proximity locations by using the coordinates. The server 106 may set a range of closeness to identify the parking locations. For example, the server 106 may identify the parking locations that are within a 5 km radius of the proximity locations. After the identification of the parking location, the server 106 may provide the parking locations to the system 200 by using the receiving unit 204.

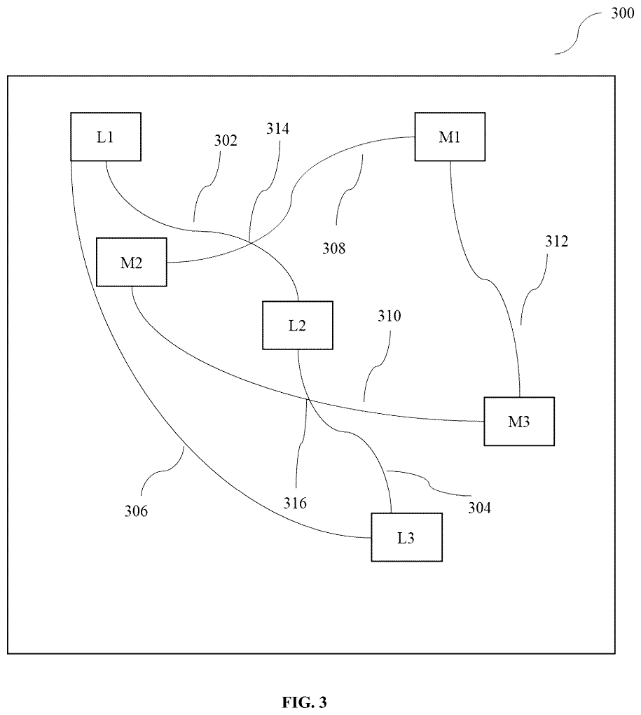

Moving towards FIG. 3, in order to explain the embodiment related to identification of the parking location described in forgoing paragraph. In a non-limiting example of the present embodiment, locations of an energy consumer vehicle may be L1, L2, and L3. The selection unit 212 may identify a proximity location of an energy supplier vehicle and the energy consumer vehicle which is 314 between the path L1-L2 and 316 between the path L2-L3. After identifying proximity locations, the extraction unit 214 may identify that the energy supplier vehicle can supply the energy to the energy consumer vehicle. After that, the system 200 may provide the proximity locations to the server 106 such as a first parking location that is close to the proximity location 314 and a second parking location that is close to the proximity location 316. The detailed description of FIG. 3 is explained in greater details in the forthcoming paragraphs.

In a non-limiting embodiment of the present disclosure, the extraction unit 214 may be configured to extract the route information and the energy consumption associated with the route information of the selected at least one energy supplier vehicle and the at least one energy consumer vehicle.

In particular, the extraction unit 214 may extract the plurality of locations and an energy consumption of location pairs of the plurality of locations for the at least one energy consumer electric vehicle and their selected energy supplier vehicle from the memory module 208.

In a non-limiting embodiment of the present disclosure, the identification unit 210 may be configured to identify an optimal route, from the extracted route information, for the at least one energy consumer vehicle and the selected at least one energy supplier vehicle.

In particular, the identification unit 210 may extract the optimal route for the at least one energy consumer vehicle and their energy supplier vehicle from the memory module 208. The extraction of the optimal route includes identification of the optimal route from the set of the routes present in the route information of the respective vehicle.

An optimal route may refer to the path that requires the least amount of energy to traverse. In other words, it is the path that minimizes the energy expenditure of a person or vehicle traveling from one point to another.

In a non-limiting embodiment of the present disclosure, the calculation unit 216 may be configured to calculate an updated optimal route for the for the at least one energy consumer vehicle and the selected at least one energy supplier vehicle based on at least one of the identified optimal route, the plurality of energy exchange locations, the extracted route information and energy consumption associated with the extracted route information, and one or more constraints.

In particular, the calculation unit 216 may receive from the extraction unit 214 the plurality of locations and an energy consumption of location pairs of the plurality of locations of the at least one energy consumer electric vehicle and their selected energy supplier vehicle from the memory module 208. The calculation unit 216 may receive these information as the route information. Simultaneously, the calculation unit 216 may receive from the identification unit 210 the plurality of energy exchange locations. Additionally, the calculation unit 216 may receive from the optimal route for the at least one energy consumer vehicle and their energy supplier vehicle. Further, the calculation unit 216 may receive delivery information and vehicle information of the at least one energy consumer vehicle and their selected energy supplier vehicle from the memory module 208. After the reception of all the information, the calculation unit 216 may calculate an updated optimal route for the at least one energy consumer vehicle and their selected energy supplier vehicle by one or more techniques, known to a person skilled in the art, to generate the updated optimal route. The one or more techniques may include, not limited to, Greedy algorithm, Reinforcement learning, algorithm, Dijkstra technique, A* search technique, A* search Landmarks and Triangle Inequality (ALT) technique, mixed Integer Linear Programming technique, and so on. The one or more techniques may calculate the updated optimal path based on serval conditions/constraints of the at least one energy suppler vehicle and the selected energy consumer electric vehicle as described below:

In an exemplary embodiment, constraint may be related to vehicle state of charge (SOC) that may not drop below the minimum SOC level. The amount of energy remaining in a battery as a percentage of its total capacity. For example, capacity of battery of the vehicle is 600 kWh. In such a case, the threshold SOC of battery of the vehicle may not be less than the 10% of the battery capacity at any point during the delivery of goods.

In an exemplary embodiment, the constraint may be related to weight of goods that may not exceed the maximum permissible weight for the vehicle. In particular, during generation of updated optimal route for the transportation of goods, it is important to consider the weight of the goods being carried by the vehicle. The weight of the goods may not exceed the maximum permissible weight for the vehicle. For example, the weight of the vehicle maybe 5 tons in such a case, total weight of goods present in the vehicle should not exceed the weight of the vehicle.

In an exemplary embodiment, the constraint may be related to the delivery time that may not exceed the maximum permissible delivery time. In particular, when generating the updated optimal route, it is important to take into account the maximum permissible delivery time. This refers to the latest time by which a delivery must be made, either due to contractual obligations or logistical considerations. For example, a delivery company may have a contract to deliver packages to a particular customer by 5 pm every day. If the delivery driver may arrive too late, causing the company to breach their contract and potentially lose the customer's business.

In an exemplary embodiment, the constraint may be related to delivery locations or plurality of locations. All the delivery locations may be covered during generation of the updated optimal route.

In an exemplary embodiment, the constraint may be related to routes. The routes may have restrictions on higher mass, vehicle dimensions (height), time of drive may be excluded during generation of the updated optimal route. For example, there may be weight restrictions on certain roads that prohibit vehicles above a certain mass from using them. Similarly, there may be height restrictions on certain bridges or tunnels that limit the maximum height of vehicles that can pass through them. In addition, there may be time restrictions on when vehicles can drive on certain roads. For example, some cities may have rules in place that prohibit large trucks from driving during rush hour to ease congestion.

In an exemplary embodiment, the constraint may be arrival of the vehicle at the delivery location/plurality of locations. The vehicle may arrive at a delivery location in the given tolerance band of the given arrival time. For example, delivery is scheduled to arrive at a location A between 10:00 am and 11:00 am. The tolerance band for this delivery may be +/−15 minutes, which means the delivery can arrive any time between 9:45 am and 11:15 am. In order to calculate the updated optimal route as described above, one or more of the exemplary embodiment of the constraint may be used.

The calculation unit 216 may calculate the updated optimal route as discussed in forgoing paragraphs of the present disclosure. In order the calculate the updated optimal route, the calculation unit 216 further consider the delivery information. Based on this calculation, the updated optimal route may suggest a start time for suggest a start time for the at least one energy consumer vehicle and the selected at least one energy supplier vehicle to minimize the waiting time and energy consumption in order to meet delivery schedules for the at least one energy consumer vehicle and the selected at least one energy supplier vehicle.

The calculation unit 216 may calculate the updated optimal route as discussed in forgoing paragraphs of the present disclosure. The calculation of the updated optimal route by using the one or more techniques may be performed to provide at least one of identification details in the updated optimal route as described below:

A first detail corresponds to selection of at least one energy supplier vehicle from the multiple energy supplier vehicles that are selected by the selection unit 212. The selection of the at least one energy supplier vehicle is further explained in FIG. 5 in forthcoming paragraphs.

A second detail corresponds to an identification of time for energy exchange between the electric vehicles is further explained in FIG. 5 in forthcoming paragraphs.

A third detail corresponds to selection of a parking location where the energy supplier vehicle and the energy consumer vehicle faces minimum deviation after the calculation of the updated optimal route. In particular, the identification unit 210 may identify the plurality of energy exchange locations as described above. After the identification of the plurality of energy exchange locations, the calculation unit 216 may receive multiple information (as described above) and the plurality of energy exchange locations and select at least one energy exchange location from the plurality of energy exchange location where the energy consumer vehicle and the selected at least one energy supplier vehicle may face minimum deviation by using one or more techniques and multiple information.

In a non-limiting example of the present disclosure, a source location and a destination location of an energy consumer electric vehicle may be L1 and intermediate stop locations may be L2 and L3. Further, a source location and a destination location of a first energy supplier vehicle may be M1 and intermediate stop locations may be M2, and M3. The system may select the first supplier vehicle from multiple supplier electric vehicles by using the routes of the location pairs. Moving on to FIG. 3, exemplary embodiment of the identification of the plurality of energy exchange locations, and selection of the energy supplier vehicle for the energy consumer vehicle. The route between location L1 and L2 of the energy consumer vehicle may be 302. A route between a location L2 and L3 of the energy consumer vehicle may be 304, A route between a location L3 and L1 of the energy consumer vehicle may be 306. A path between location M1 and M2 of the energy supplier vehicle may be 308. A route between location M2 and M3 of the energy supplier vehicle may be 310. A route between location M3 and M1 of the energy supplier vehicle may be 312.

Thereafter, the system 200 may identify proximity locations 314 and 316 between the routes of the energy supplier vehicle and energy consumer vehicle. If the intersections are present or route of the energy supplier electric vehicle may be in proximity to the route of the energy consumer electric vehicle, the system 200 may identify that the energy supplier vehicle which may supply the energy to the energy consumer vehicle. Sequentially, the system 200 may identify the location coordinates of proximity locations 314 and 316. After the identification of the location coordinates, the system 200 may identify parking location that is in proximity of the proximity locations 314 and 316. The calculation unit 216 may calculate the updated optimal route for the energy supplier vehicle and energy consumer electric vehicle. The optimal route may indicate the parking location where the energy supplier electric vehicle and the energy consumer electric vehicle may exchange the energy.

In a non-limiting embodiment of the present disclosure, the recommendation unit 218 may recommend the updated optimal route for the at least one energy supplier vehicle and the at least one energy consumer vehicle for V2V energy exchange, indicating at least one energy exchange location from the identified plurality of energy exchange locations and duration of energy exchange.

In particular, the recommendation unit 218 may receive the updated optimal route from the calculation unit 216. After receiving the updated optimal route, the recommendation unit 218 may recommend the updated optimal route of the energy consumer vehicle, to the energy supplier vehicle by providing the updated optimal route to the transmitting unit 206. The transmitting unit 206 may transmit the updated optimal route to the energy consumer vehicle. Simultaneously, the recommendation unit 218 may recommend the updated optimal route of the at least one energy supplier vehicle that is associated with the energy consumer vehicle, to the at least one energy supplier vehicle by providing the updated optimal route to the transmitting unit 206. The transmitting unit 206 may transmit the updated optimal route to the selected at least one energy suppler vehicle. After the transmitting the updated optimal route, the energy consumer vehicle may establish communication with the selected at least one energy supplier vehicle.

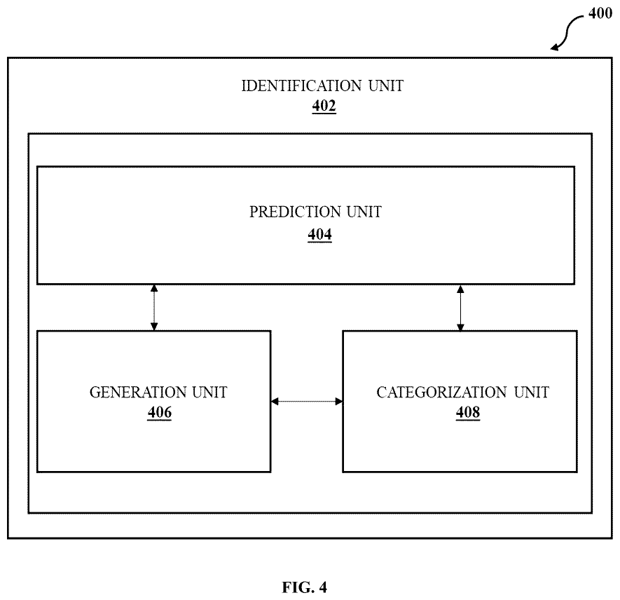

Moving on to FIG. 4 that illustrates system 400 (same as the system 200 of FIG. 2) to recommend energy efficient routes to vehicles, for V2V energy exchange, in accordance with an embodiment of the present disclosure. As discussed in forgoing paragraphs in view of description of FIG. 2, the system 400 may include an identification unit 402 (same as the identification unit 210 of FIG. 2) that may be configured to identify at least one energy consumer vehicle and one or more energy supplier vehicles from the one or more electric vehicles. The constituent elements of the identification unit 402 may include one or more sub-units including but not limited to a prediction unit 404, a generation unit 406, and categorization unit 408. All the constituent elements of the identification unit 402 illustrated in FIG. 4 are essential constituent elements, and the identification unit 402 may be implemented by more constituent elements than the constituent elements illustrated in FIG. 4, however the same are not explained for the sake of brevity. All the constituent elements of the identification unit 402 may communicate with each other via wireless/wired communication network.

In a non-limiting embodiment of the present disclosure, a receiving unit (such as the receiving unit 204 of the FIG. 2) may be configured to receive the route information of each of the plurality of vehicles. After that, the prediction unit 404 may be configured to predict energy consumption of each of the plurality of vehicles based on the route information. The energy consumption of each of the plurality of vehicles is predicted at multiple time instances during a travel.

In particular, the receiving unit 204 may receive the route information, delivery information, vehicle information, and velocity profile of the plurality of vehicles as described in FIG. 2 of the present disclosure. The route information includes real-time information about traffic conditions, the information about the current state of roads, and the plurality of locations.

The prediction unit 404 may receive the plurality of locations of the each of the plurality of vehicles. After receiving, the prediction unit 404 may determine location pairs for each of the plurality of electric vehicles.

After determining the location pairs of each of the plurality of vehicles, the prediction unit 404 may predict energy consumption of each of the plurality of electric vehicles. Let us assume the prediction of energy consumption of the location pairs for one electric vehicle. The prediction of energy consumption for one electric vehicle is same for other electric vehicles. After the determination of the location pairs, the prediction unit 404 may predict energy consumption of the electric vehicle for each of the location pairs. The prediction unit 404 may predict the energy consumption for multiple time intervals of a day. The prediction unit 404 may use at least one technique to predict the energy consumption. The at least one technique may be, for example, a data-driven model like MLR model technique, an Artificial neural networks (ANN) technique, a support vector mechanism technique, a random forest technique, or a rule-based model where several fundamental physics laws are used to mimic the dynamics and interactions of vehicle and powertrain components. The energy consumption may be the amount of energy or power used by the electric vehicle. The multiple time intervals of the day may be within a travel period which is to be travelled by the vehicle. The multiple time intervals may be different time instances during the day when the energy consumption of the vehicle may be minimum.

In a non-limiting example of present disclosure, consider the different time instances to be 7 am, 9 am, and 1 μm of the day. At 7 am of the day, traffic may be very less due to less vehicles commuting in morning. Therefore, the energy consumption for the location pairs may be less at 7 am. At 9 am of the day, traffic may be high due to office hours and energy consumption may be more for the one or more location pairs at 9 am. At 1 μm of the day traffic may be very less due to lunch hour and the energy consumption may be less for the one or more location pairs at 1 μm. In an embodiment, the multiple time intervals of the day are considered within a travel period of the electric vehicle. For example, the vehicle may be given a time limit of 8 am to 6 μm to deliver the goods. Hence, the multiple time intervals are selected to be within 8 am to 6 μm. In an embodiment, the time limit may be the number of hours the driver of the electric vehicle may be allowed to drive to deliver the goods.

The prediction unit 404 may predict the energy consumption of the vehicle for the location pairs based on the route information, velocity profile of the vehicle, and vehicle information.

In a non-limiting embodiment of the present disclosure, the generation unit 406 may be configured to generate the optimal route for each of the plurality of vehicles based on the predicted energy consumption.

In particular, let us assume the generation of optimal route for one electric vehicle based on the energy consumption predicted by the prediction unit 404. The generation of the optimal route for one electric vehicle is same for other electric vehicles. The generation unit 406 may receive the delivery information from the receiving unit 204 and may generate the optimal route for the vehicle. The optimal route may be generated based on the energy consumption, delivery information, and the plurality of location pairs, and one or more constraints. In an embodiment, the one or more constraints may relate to permissible weight of the vehicle and time of delivery at the plurality of locations. The permissible weight of the vehicle may be the total weight of the electric vehicle. The time of delivery at the plurality of locations is within the travel period which is to be travelled by the electric vehicle. Further, the generation unit 406 may determine energy consumption of the vehicle by using the optimal route and the energy consumption of the location pairs.

Table 1 indicates the plurality of locations, weight of goods to be delivered, weight of goods to be picked-up and the respective predefined time for the electric vehicle. The electric vehicle needs to deliver goods of weight 1 ton between 10-11 at the first location A as shown in Table 2. The electric vehicle needs to pick-up goods of weight 3 ton between 13-14 at the second location B as shown in Table 2. The electric vehicle C needs to deliver goods of weight 2 ton and needs to pick-up goods of weight 5 ton between 17-18 at the third location C as shown in Table 2. The electric vehicle needs to deliver good of weight 4 ton between 19-20 at fourth location D.

TABLE 1

| Plurality of | Delivery | Pick-up | Predefined |
|---|---|---|---|
| Locations | of goods | goods | Time |
| A | 1 ton | | 10-11 |
| B | | 3 ton | 13-14 |
| C | 2 ton | 5 ton | 17-18 |
| D | 4 ton | | 19-20 |

In a non-limiting embodiment of the present disclosure, categorization unit 408 may be configured to categorize the plurality of vehicles as energy consumer vehicle based on energy consumption on the generated optimal route.

In particular, the categorization unit 408 may receive initial SOC of a battery the plurality of vehicles from the receiving unit 204. Simultaneously, the categorization unit 408 may receive the energy consumption of the plurality of vehicles for their optimal route. The categorization unit 408 may compare, for each of the one or more electric vehicles, initial SOC of the battery with the energy consumption of vehicle for the respective optimal route. After the comparison, the categorization unit 408 may categorize the plurality of vehicles into energy consumer vehicle or energy supplier vehicle. If the initial SOC of the battery is less than the energy consumption, then the categorization unit 408 may categorize the electric vehicle as the energy consumer vehicle. If the initial SOC of the battery is greater than the energy consumption, then the categorization unit 410 may categorize the vehicle as the energy supplier electric vehicle.

The plurality of vehicles mentioned in a process related to FIG. 4, may be one or more set of electric vehicles 104 of FIG. 1. The system 400 may store the categorization of the one or more electric vehicle in a memory module (such as the memory module 208 of FIG. 2).

Table 2 may illustrate categorization of each of the electric vehicles 104 either in energy supplier electric vehicle or energy consumer electric vehicle. EV1 may be an energy consumer vehicle because its battery energy of 20 kWh is less than the optimal route energy of 25 kWh. EV2 may be an energy consumer vehicle because its battery energy of 30 kWh is less than the optimal route energy of 35 kWh. EV3 may be an energy donor vehicle because its battery energy of 40 kWh is greater than the optimal route energy of 35 kWh.

TABLE 2

| | Battery Energy | Optimal Route | |
|---|---|---|---|
| Vehicle | (kWh) | Energy (kWh) | Categorization |
| EV1 | 20 | 25 | Energy Consumer |
| EV2 | 30 | 34 | Energy Consumer |
| EV3 | 40 | 35 | Energy Supplier |

Moving on to FIG. 5 that illustrates a system 500 (same as the system 200 of FIG. 5 2) for recommending energy efficient routes to vehicles, for V2V energy exchange, in accordance with an embodiment of the present disclosure. As discussed in forgoing paragraphs in view of description of FIG. 2, the system 500 may include a selection unit 502 (same as the selection unit 212 of FIG. 2) that may be configured to select the identified at least one energy consumer vehicle. Further, the system 500 may include a calculation unit 504 (same as the calculation unit 216 of FIG. 2) that may be configured to calculate the updated optimal route for the at least one energy supplier electric vehicle of the plurality of energy supplier electric vehicles and for at least one energy consumer electric vehicle. Furthermore, the system 500 may include a generation unit 506 that may be configured to generate updated optimal route for the at least one energy supplier electric vehicle of the plurality of energy supplier electric vehicles and for at least one energy consumer electric vehicle. The constituent elements of the system 500 may include one or more sub-units including but not limited to the selection unit 502, the calculation unit 504, and a generation unit 506. All the constituent elements of the system 500 illustrated in FIG. 5 are essential constituent elements, and the system 500 may be implemented by more constituent elements than the constituent elements illustrated in FIG. 5, however the same are not explained for the sake of brevity. All the constituent elements of the system 500 may communicate with each other via wireless/wired communication network.

In a non-limiting embodiment of the present disclosure, the receiving unit (such as the receiving unit 204 of FIG. 2) may be configured to receive the route information of the one or more energy supplier vehicle and the energy consumer vehicle.

In particular, the receiving unit 204 may receive the route information, delivery information, vehicle information, and velocity profile as mentioned in FIG. 2. After that, the receiving unit 204 may provide the route information to the memory module (such as the memory module 208 of FIG. 2). The selection unit may extract these information, after the categorization of the plurality of vehicles, of the at least one energy consumer vehicle and the one or more energy supplier vehicle. Further, the selection unit may extract the energy consumption associated with the route information of the of the at least one energy consumer vehicle and the one or more energy supplier vehicle.

In an alternative embodiment, the receiving unit 204 may receive the plurality of locations, delivery information, vehicle information of at least one energy consumer vehicle delivery information. After that, the system 500 may transmit a request to the server (such as the server 106 of FIG. 1) via the transmitting unit (such as the transmitting unit 206 of FIG. 2) to receive the route information and velocity profile of the at least one energy consumer electric vehicle. The request is transmitted along with the plurality of locations of each of the at least one energy consumer electric vehicle. The selection unit 502 may receive the route information of the at least one energy consumer electric vehicle from the receiving unit (such as the receiving unit 204 of the FIG. 2). After that, the selection unit 502 may identify, for each of the at least one energy consumer vehicle, energy consumption associated with plurality of locations by using a procedure same as mentioned in the description of FIG. 4. Further, the selection unit 502 may extract the route information, delivery information, vehicle information, and velocity profile of the one or more energy supplier electric vehicles from the memory module 208.

In a non-limiting embodiment of the present disclosure, the selection unit 502 may be configured to identify at least one energy supplier vehicle from the one or more energy supplier vehicles based on the received route information and at least one of waiting time, delivery information, minimum detour, and charging rate of the one or more energy supplier vehicles.

In particular, after categorization of the plurality of vehicles, the system 500 may transmit a request via the transmitting unit 206 to the identified one or more energy supplier vehicles to receive charging information of the each of the one or more energy supplier vehicles. The charging information may include a charging rate and charging price. The charging rate may refer to a rate at which energy may be delivered to the energy consumer electric vehicle. The charging rate of a supplier is an important consideration for electric vehicle owners, as it can affect the time it takes to charge the vehicle's battery. A higher charging rate can reduce the time required to charge the battery, while a lower charging rate may result in longer charging times. The charging price may refer to the cost that energy supplier vehicle owners may charge to the energy consumer electric vehicle. The selection unit 502 may receive the charging information of the energy supplier electric vehicles and the at least one energy consumer electric vehicle from the receiving unit 204.

Firstly, the selection unit 502 may select at energy supplier vehicles from the plurality of energy supplier electric vehicles based by the proximity route as described in description of the selection unit 212 of FIG. 2.

After the selection of the energy supplier vehicles for the at least one energy consumer vehicle based on the proximity analysis, the selection unit 502 may identify the at least one energy suppler vehicle for each of the at least one energy consumer vehicle based on charging information of the plurality of energy supplier electric vehicles, route information, delivery information, energy consumption of energy supplier electric vehicles and the at least one energy consumer electric vehicle.

Table 3 may illustrate parameters which may consider in order to identify the at least one energy consumer electric vehicle from the plurality of energy supplier electric vehicles. The table 3 lists three different electric vehicles (Vehicle A, Vehicle B, and Vehicle C) along with several factors that are relevant for selecting the best vehicle for supplying energy to the at least one energy consumer electric vehicle.

The first factor listed is the charging rate of each vehicle, measured in kilowatts (KW). The higher the charging rate, the faster the vehicle can charge its battery. In this case, Vehicle C has the highest charging rate at 150 KW, while Vehicle A has the lowest at 50 kW. The next two columns represent the waiting time of both the energy consumer vehicle and the energy supplier vehicle. A shorter waiting time is generally preferred, as it reduces the overall time required for the delivery. In this case, Vehicle C has the shortest waiting times for both vehicles at 30 minutes and 15 minutes, respectively. The following two columns represent any changes to the delivery schedule for both the energy consumer vehicle and the energy supplier vehicle. In this case, there is no change to the delivery schedule for Vehicle C, while Vehicle A requires the energy consumer vehicle to arrive 5 minutes earlier than planned. Vehicle B requires the energy supplier vehicle to arrive 5 minutes earlier than planned. The next column represents the deviation of path for each vehicle. This factor is important because it can impact the efficiency of the delivery, as a longer path may require more time or resources. In this case, Vehicle C has the least deviation of path at 0.5 km. The next column represents the waiting time of the energy consumer vehicle when taking into account the charging time required for the selected vehicle. This is important because the energy consumer vehicle must wait for the energy supplier vehicle to arrive and charge its battery before continuing with the delivery. In this case, Vehicle C has the shortest waiting time at 45 minutes, which includes the time required for charging.

TABLE 3

| | | | | | Change | | |
|---|---|---|---|---|---|---|---|
| | | | | | in | | Waiting |
| | | Waiting | Waiting | Change in | Delivery | | Time of |
| | | Time of | Time of | Delivery | Schedule | | Energy |
| | | Energy | Energy | Schedule | of | | Consumer |
| | Charging | Consumer | Supplier | of Energy | Energy | Deviation | Vehicle |
| Electric | Rate | Vehicle | Vehicle | Consumer | Supplier | of Path | (with |
| Vehicle | (kW) | (min) | (min) | Vehicle | Vehicle | (km) | charging) |
| Vehicle | 50 | 60 | 30 | 5 minutes | No | 2 | 75 |
| A | | | | earlier | change | | |
| Vehicle | 100 | 45 | 20 | No | 5 | 1 | 65 |
| B | | | | change | minutes | | |
| | | | | | earlier | | |
| Vehicle | 150 | 30 | 15 | No | No | 0.5 | 45 |
| C | | | | change | change | | |

In a non-limiting embodiment of the present disclosure, the updated optimal route for the at least one energy supplier electric vehicle and updated optimal route for energy consumer electric vehicle include time information and energy exchange information. The time information may correspond to a time for exchange of energy between the at least one energy supplier electric vehicle. The energy exchange information may include amount of energy exchanged between the at least one energy supplier electric vehicle and for energy consumer electric vehicle, time of energy exchange, and the energy exchange location.

After the identification of the at least one energy supplier electric vehicle. The selection unit 502 may provide the identification the at least one energy supplier electric, to the calculation unit 504 along with the charging information. The calculation unit 504 may calculate the updated optimal route and charging time of exchange of energy between the at least one energy supplier electric vehicle and the energy consumer electric vehicle. The charging time may be part of the energy exchange information. The calculation of the updated optimal route is same as the description of the calculation unit 216 of FIG. 2. Further, the calculation of the charging time as described below:

The calculation unit 504 may calculate the charging time of exchange of energy between the at least one energy supplier electric vehicle and the energy consumer electric vehicle. The charging time may be dependent on the charging rate. Apart from the charging rate, several other parameters affect the charging time of exchange of energy. For example, battery capacity of the energy consumer electric vehicle, state of charge of energy consumer electric vehicle, charging technology, and so forth. The calculation unit 504 may extract the battery characteristics and SOC of the energy consumer electric vehicle from the memory module 208.

The battery capacity may affect the charging time. For example, the size of the battery in the vehicle being charged can impact the charging time. A larger battery will take longer to charge than a smaller one. State of charge may affect the charging time: For example, If the battery is close to being fully charged, the charging time will be shorter than if it is nearly empty. Charging technology may also impact the charging time.

After the calculation of the charging time, the calculation unit 504 may provide the calculation of the updated optimal route for the identified at least one energy supplier electric vehicle and energy consumer electric vehicle to the generation unit 506. Simultaneously, the calculation unit 504 may provide the charging time of exchange of energy to the generation unit 506. The calculation of the updated optimal route include calculation of route for energy supplier electric vehicle and energy consumer electric vehicle, determination of a parking location at which energy exchange take place, calculation of a time to reach multiple locations, calculation of available energy at multiple locations, calculation of available energy after end of route, and calculation of amount of energy exchange between the identified at least one energy supplier electric vehicle and energy consumer electric vehicle.

The generation unit 506 may receive the calculation of the updated optimal route and the charging time of exchange of energy, the generation unit 506 may have one or more technique to generate the graphical representation of the updated optimal route. The one or more technique may be, not limited to, 3D modeling technique, GIS mapping technique, augmented reality technique, and so forth.

In an embodiment, the energy consumer vehicle may consume the energy from both of the energy supplier vehicle and energy charging station in a certain conditions. For example, if the energy consumer vehicle may require some energy to perform transportation of goods and all the associated energy supplier vehicles unable to provide sufficient energy to the energy consumer vehicle. In this scenario, the energy consumer vehicle may charge the vehicle from the charging station.

In an embodiment, the energy exchange updated optimal routes may be generated to minimize cost of travel for multiple energy consumer electric vehicles and multiple energy supplier electric vehicles. The minimization of the cost of travel for multiple energy consumer electric vehicles and multiple energy supplier electric vehicle using equation 1 given below.

$$min ( Charging cost of all vehicles ) ⇒ min {LC}_{i} \begin{matrix}N \\ i\end{matrix} \qquad ( 1 )$$

where,
Cᵢ is the effective charging cost of a vehicle at i^{th} route, and
N is the total number of routes for the vehicle.

The term Cᵢ for the energy consumer electric vehicle is calculated using equation 2 given below:

$${C}_{i} ( for recipient vehicle ) = L {E}_{j} {{*}^{n}}_{j = l} {c}_{j} + ( {E}_{d} - {E}_{r} ) * {c}_{d} + L ( {E}_{v 2 v} {{*}^{m}}_{k = l} {c}_{v 2 v} ) k \qquad ( 2 )$$

Where
cⱼ is the charging cost per kWh at “j” charging station,
Eⱼ is the charging energy at “j” charging station,
n is the number of times a vehicle goes to charging station,
Cᵥ₂ᵥ is the charging cost per kWh for V2V charging at “k” instance,
Eᵥ₂ᵥ is the energy received during V2V charging at “k” instance,
m is the number of times a vehicle goes for V2V charging,
E_{d} is the energy charged from the depot location,
C_{d} is the charging cost at depot location,
Eᵣ is the available energy at the end of the route.

Further, the term Cᵢ for the energy consumer electric vehicle is calculated using equation 3 given below:

$${C}_{i} ( for donor vehicle ) = L {E}_{j} {{*}^{n}}_{j = l} {c}_{j} + ( {E}_{d} - {E}_{r} ) * {c}_{d} - L ( {E}_{v 2 v} {{*}^{m}}_{k = l} {c}_{v 2 v} ) k \qquad ( 3 )$$

Where,
cⱼ is the charging cost per kWh at “j” charging station, and cⱼ<cᵥ₂ᵥ for inter fleet trucks,
Eⱼ is the charging energy at “j” charging station,
Cᵥ₂ᵥ is the charging cost per kWh for V2V charging at “k” instance,
c_{d} is the charging cost per kWh at the depot location, and c_{d}<cᵥ₂ᵥ for inter fleet trucks,
Eᵥ₂ᵥ is the energy transferred during V2V charging at “k” instance,
n is the number of times a vehicle goes to charging station,
m is the number of times a vehicles goes for V2V charging,
E_{d} is the energy charged from the depot location,
Eᵣ is the available energy at the end of the route.

In a non-limiting embodiment of the present disclosure, the system 500 may be configured to identify, in real-time, a deviation in the updated optimal route of the at least one of the energy consumer vehicle and the selected at least one energy supplier vehicle.

In particular, an energy consumer electric vehicle or energy supplier electric vehicle may deviate from the updated optimal route. Deviations from a predefined route may occur due to a variety of factors, including traffic congestion, road closures, accidents, construction work, and weather conditions. These factors can cause the electric vehicle to have to take a different route to reach its destinations. The system 500, by using an identification unit (such as the identification unit 210 of FIG. 2) may identify the deviation as the system 500 may be in real time communication with the energy supplier electric vehicle and energy consumer electric vehicle. After receiving the deviation, the system 500 may receive current location from the deviated vehicle or the system 500 may extract the information based on the real time communication.

In a non-limiting embodiment of the present disclosure, the calculation unit 504 resequence the updated optimal route for the energy consumer vehicle, in response to identification of the deviation in the updated optimal route.

In particular, the calculation unit 504 may receive path deviation information energy consumer electric vehicle or energy supplier electric vehicle. After receiving the information, the calculation unit 504 may re-sequence the updated optimal route of the energy consumer electric vehicle by using a procedure same as the procedure of calculation of the updated optimal route for the identified energy consumer vehicle.

In a non-limiting example of the present disclosure, the updated optimal route for energy consumer electric vehicle may be A1 [symbol] A2 [symbol] A3 [symbol] A4_A5 and the updated optimal route for energy supplier electric vehicle may be B1 [symbol] B2 [symbol] B3_B4_B5. Let us consider a scenario in which the energy consumer electric vehicle may deviate from the updated optimal route. The energy consumer electric vehicle may visit the location A1 and then may visit the location A2. Upon visiting the location A2, the next location to be visited may be location A3 as per the updated optimal route. However, the driver mistakenly takes another direction or the drive intentionally take another route due to obstruction in updated optimal route. In such a case, the generation unit 506 may be configured to provide re-sequence route based on current location of the energy consumer electric vehicle. The re-sequence route may provide an updated parking location where the exchange of energy takes place. In an embodiment, the re-sequence route may include exchange of energy either with the same energy supplier electric vehicle or with different energy supplier electric vehicle. The calculation of re-sequence route of the energy supplier vehicle is same as the calculation of the updated route of the identified energy consumer vehicle described in the description of the FIG. 2.

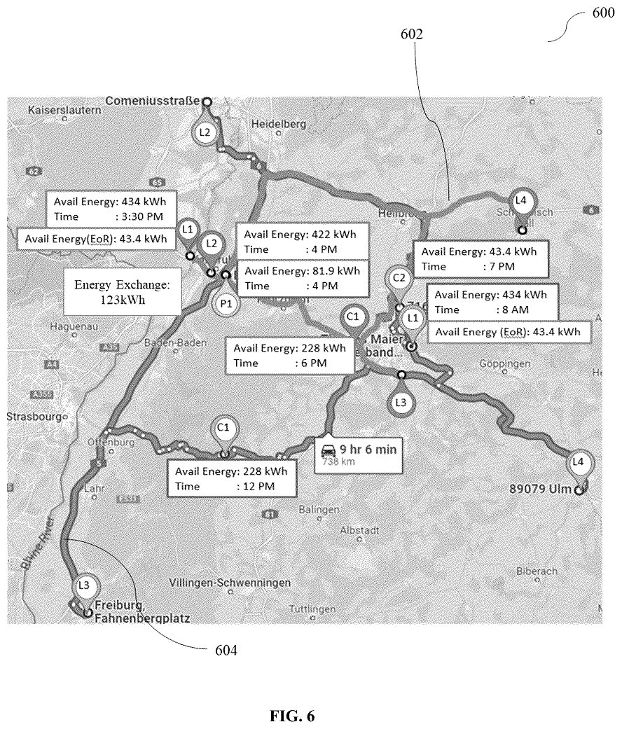

Moving on to FIG. 6 that illustrates an exemplary embodiment of the updated optimal route 600 generated by the generation unit (such as the generation unit 506 of FIG. 5). The updated optimal route may include updated optimal route 602 of the energy supplier electric vehicle and updated optimal route 604 of the energy consumer electric vehicle. In order to differentiate the updated optimal routes 602, 604 in FIG. 6 and to increase the visibility of the updated optimal routes 602, 604 different color coding is used. For example, the color coding for the optimal route 602 may be orange and color coding for the optimal route 604 may be blue. The optimal route 602 of the energy supplier electric vehicle may be L1_P1 [symbol] C1 [symbol] L3_L4_L2 [symbol] L1. The optimal route 602 may include energy available/remaining at multiple locations along with time to reach multiple locations. For example, the available energy at location L1 is 434 kWh at time 3.30 PM and available energy at location C1 is 228 kWh at time 6 PM. Further, the optimal route 602 may include available energy after end of the route. The available energy of the energy supplier electric vehicle after the end of the optimal route may be 43.4 kWh. Further, the optimal route 602 may include a parking location at which the energy supplier electric vehicle may supply the energy to the energy consumer electric vehicle.

The optimal route 604 of the energy supplier electric vehicle may be L1 [symbol] L4 [symbol] C1 [symbol] L3 [symbol] P1 [symbol] L2 [symbol] C2 [symbol] L1. The optimal route 604 may include energy available/remaining at multiple locations along with time to reach multiple locations. For example, the available energy at location L1 is 434 kWh at time 8 AM, available energy at location C1 is 228 kWh at time 12 PM, available energy at location C2 is 43.4 kWh at time 7 PM. Further, the optimal route 604 may include available energy after the end of the route. The available energy of the energy consumer electric vehicle after the end of end of the optimal route 604 may be 43.4 kWh. Further, the optimal route 604 may include parking location P1 at which the energy supplier electric vehicle may supply the energy to the energy consumer electric vehicle.

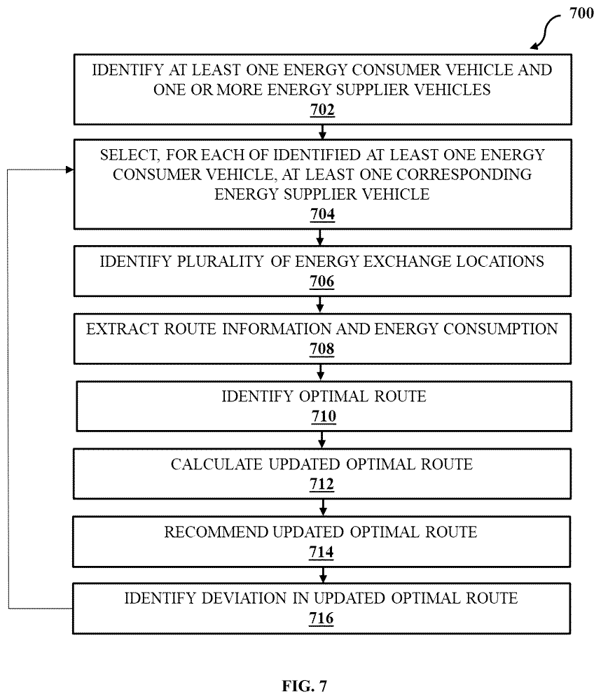

FIG. 7 is a flowchart showing steps of a method for recommending energy efficient routes to vehicles, for V2V energy exchange performed by a system (such as system 200 of FIG. 2). The method starts at step 702, at a step 702 the method 700 may include identifying at least one energy consumer vehicle and one or more energy supplier vehicles, among a plurality of vehicles, based on route information of the plurality of vehicles and energy consumption associated with the route information. The identification of the at least one energy consumer vehicle and one or more energy supplier vehicles include receiving the route information of each of the plurality of vehicles and predicting energy consumption of each of the plurality of vehicles based on the route information. The energy consumption of each of the plurality of vehicles is predicted at multiple time instances during a travel. Sequentially, the identification of the at least one energy consumer vehicle and one or more energy supplier vehicles include generating the optimal route for each of the plurality of vehicles based on the predicted energy consumption and categorizing the plurality of vehicles as energy consumer vehicle based on energy consumption on the generated optimal route. In an exemplary aspect, an identification unit 210 of FIG. 2 of a system 200 of FIG. 2 may be configured to carry out the process steps disclosed in step 702.

At a step 704, the method 700 may include selecting, for each of the identified at least one energy consumer vehicle, at least one corresponding energy supplier vehicle from the identified one or more energy supplier vehicles based on at least one proximity location. The proximity location corresponds to a location at which routes of the selected energy consumer vehicle and the selected at least one energy supplier vehicle either interact or are in close proximity to each other. The selection of the at least one corresponding energy supplier vehicle include receiving the route information of the one or more energy supplier vehicle and the energy consumer vehicle and identifying at least one energy supplier vehicle from the one or more energy supplier vehicles based on the received route information and at least one of waiting time, delivery information, minimum detour, and charging rate of the one or more energy supplier vehicles. In an exemplary aspect, the selection unit 212 of FIG. 2 of the system 200 may be configured to carry out the process steps disclosed in step 704.

At a step 706, the method 700 may include identifying a plurality of energy exchange locations based on the proximity locations. In an exemplary aspect, the identification unit 210 may be configured to carry out the process steps disclosed in step 706.

At a step 708, the method 700 may include extracting the route information and the energy consumption associated with the route information of the selected at least one energy supplier vehicle and the at least one energy consumer vehicle. In an exemplary aspect, an extraction unit 214 of the system 200 may be configured to carry out the process steps disclosed in step 708.

At a step 710, the method 700 may include identifying an optimal route, from the extracted route information, for the at least one energy consumer vehicle and the selected at least one energy supplier vehicle. In an exemplary aspect, the identification unit 210 may be configured to carry out the process steps disclosed in step 710.

At a step 712, the method 700 may include calculating an updated optimal route for the selected at least one energy supplier vehicle and for the at least one energy consumer vehicle based on at least one of the identified optimal route, the plurality of energy exchange locations, the extracted route information and energy consumption associated with the extracted route information, and one or more constraints. The updated optimal route for the selected at least one energy supplier vehicle and for the energy consumer vehicle include energy exchange information. The energy exchange information includes amount of energy to be exchanged between the selected at least one energy supplier vehicle and energy consumer vehicle, time for energy exchange, and the energy exchange location. In an exemplary aspect, a calculation unit 216 of the system 200 may be configured to carry out the process steps disclosed in step 712.

At a step 714, the method may include recommending the updated optimal route for the at least one energy supplier vehicle and the at least one energy consumer vehicle for V2V energy exchange, indicating at least one energy exchange location from the identified plurality of energy exchange locations and duration of energy exchange. In an exemplary aspect, a recommendation unit 218 of the system 200 may be configured to carry out the process steps disclosed in in step 714.

At a step 716, the method may include identifying, in real-time, a deviation in the updated optimal route of the at least one of the energy consumer vehicle and the selected at least one energy supplier vehicle. In an exemplary aspect, the identification unit 210 may be configured to carry out the process steps disclosed in step 716.

After the identification of the deviation, the method includes resequencing the updated optimal route for the energy consumer vehicle, in response to identifying the deviation in the updated optimal route. The step for resequencing the updated optimal route is from 604-614.

The technical effect associated with the present disclosure as shown below:

The embodiment of the present disclosure may provide most energy-efficient route for vehicles along with an V2V charging which enable the vehicles to reduce their operating costs and enables the vehicles to plan longer routes without worrying about running out of battery power.

An embodiment of the present disclosure may provide an optimal route along with V2V charging options to enable the vehicle for planning longer route without the requirement of for external charging.

An embodiment of the present disclosure may reduce travelling cost of the vehicles by using V2V charging and optimal route for travelling.

An embodiment of the present disclosure may provide recommendation for next optimal route when the driver deviates from the given optimal route which maintain efficient operations of the vehicles even when unexpected events occur during the journey.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used herein, the term unit may be implemented in hardware and/or in software. If the unit is implemented in hardware, the unit may be configured as a device, e.g., as a computer or as a processor or as a part of a system, e.g., a computer system. If the unit is implemented in software, the unit may be configured as a computer program product, as a function, as a routine, or as a program code.

The hardware used to implement the various illustrative logics, logical blocks, modules, and circuits described in connection with the aspects disclosed herein may include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively or additionally, some steps or methods may be performed by circuitry that is specific to a given function.

In one or more example embodiments, the functions described herein may be implemented by special-purpose hardware or a combination of hardware programmed by firmware or other software. In implementations relying on firmware or other software, the functions may be performed as a result of execution of one or more instructions stored on one or more non-transitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

We claim:

1. A method (700) for recommending energy efficient routes to vehicles, for V2V energy exchange, comprising:
identifying (702) at least one energy consumer vehicle and one or more energy supplier vehicles, among a plurality of vehicles, based on route information of the plurality of vehicles and energy consumption associated with the route information;
selecting (704), for each of the identified at least one energy consumer vehicle, at least one corresponding energy supplier vehicle from the identified one or more energy supplier vehicles based on at least one proximity location, wherein the proximity location corresponds to a location at which routes of the selected energy consumer vehicle and the selected at least one energy supplier vehicle either interact or are in close proximity to each other;
identifying (706) a plurality of energy exchange locations based on the proximity locations;
extracting (708) the route information and the energy consumption associated with the route information of the selected at least one energy supplier vehicle and the at least one energy consumer vehicle;
identifying (710) an optimal route, from the extracted route information, for the at least one energy consumer vehicle and the selected at least one energy supplier vehicle;
calculating (712) an updated optimal route for the selected at least one energy supplier vehicle and for the at least one energy consumer vehicle based on at least one of the identified optimal route, the plurality of energy exchange locations, the extracted route information and energy consumption associated with the extracted route information, and one or more constraints; and
recommending (714) the updated optimal route for the at least one energy supplier vehicle and the at least one energy consumer vehicle for V2V energy exchange, indicating at least one energy exchange location from the identified plurality of energy exchange locations and duration of energy exchange.

2. The method (700) as claimed in claim 1, wherein the identification of the at least one energy consumer vehicle comprises:
receiving (702) the route information of each of the plurality of vehicles;
predicting (702) energy consumption of each of the plurality of vehicles based on the route information, wherein the energy consumption of each of the plurality of vehicles is predicted at multiple time instances during a travel;
generating (702) the optimal route for each of the plurality of vehicles based on the predicted energy consumption; and
categorizing (702) the plurality of vehicles as energy consumer vehicle based on energy consumption on the generated optimal route.

3. The method (700) as claimed in claim 1, wherein the selection of the at least one energy supplier vehicle further comprising:
receiving (704) the route information of the one or more energy supplier vehicles; and
identifying (704) at least one energy supplier vehicle from the one or more energy supplier vehicles based on the received route information and at least one of waiting time, delivery information, minimum detour, charging rate of the one or more energy supplier vehicles, wherein the charging rate is energy exchange rate of the one or more energy supplier vehicles.

4. The method (700) as claimed in claim 1, wherein the updated optimal route for the selected at least one energy supplier vehicle and for the energy consumer vehicle include energy exchange information, and wherein the energy exchange information includes amount of energy to be exchanged between the selected at least one energy supplier vehicle and energy consumer vehicle, time for the energy exchange, and the energy exchange location.

5. The method (700) as claimed in claim 1, further comprising:
identifying (714), in real-time, a deviation in the updated optimal route of the at least one of the energy consumer vehicle and the selected at least one energy supplier vehicle; and
resequencing the updated optimal route for the energy consumer vehicle, in response to identifying the deviation in the updated optimal route.

6. A system (200) for recommending energy efficient routes to vehicles, for V2V energy exchange, comprising:
one or more processing unit (202) configured to:
identify at least one energy consumer vehicle and one or more energy supplier vehicles, among a plurality of vehicles, based on route information of the plurality of vehicles and energy consumption associated with the route information;
select, for each of the identified at least one energy consumer vehicle, at least one corresponding energy supplier vehicle from the identified one or more energy supplier vehicles based on at least one proximity location, wherein the proximity location corresponds to a location at which routes of the selected energy consumer vehicle and the selected at least one energy supplier vehicle either interact or are in close proximity to each other;
identify a plurality of energy exchange locations based on the proximity locations;
extract the route information and the energy consumption associated with the route information of the selected at least one energy supplier vehicle and the at least one energy consumer vehicle;
identify an optimal route, from the extracted route information, for the at least one energy consumer vehicle and the selected at least one energy supplier vehicle; and calculate an updated optimal route for the at least one energy consumer vehicle and the selected at least one energy supplier vehicle based on at least one of the identified
optimal route, the plurality of energy exchange locations, the extracted route information and energy consumption associated with the extracted route information, and one or more constraints; and
recommend the updated optimal route for the at least one energy supplier vehicle and the at least one energy consumer vehicle for V2V energy exchange, indicating at least one energy exchange location from the identified plurality of energy exchange locations and duration of energy exchange.

7. The system (200) as claimed in claim 6, further comprising a receiving unit (204) configured to receive the route information of each of the plurality of vehicles, wherein one or more processing unit (202) is further configured to:
predict energy consumption of each of the plurality of vehicles based on the route information, wherein the energy consumption of each of the plurality of vehicles is predicted at multiple time instances during a travel;
generate the optimal route for each of the plurality of vehicles based on the predicted energy consumption; and
categorize the plurality of vehicles as energy consumer vehicle based on energy consumption on the generated optimal route.

8. The system (200) as claimed in claim 6, further comprising:
a receiving unit (204) configured to receive the route information of the one or more energy supplier vehicles,
wherein the one or more processing unit (202) is further configured to:
identify at least one energy supplier vehicle from the one or more energy supplier vehicles based on the received route information and at least one of waiting time, delivery information, minimum detour, and charging rate of the one or more energy supplier vehicles, the charging rate is energy exchange rate of the one or more energy supplier vehicles; and
suggest a start time for the at least one energy consumer vehicle and the selected at least one energy supplier vehicle to minimize the waiting time and energy consumption in order to meet delivery schedules for the at least one energy consumer vehicle and the selected at least one energy supplier vehicle.

9. The system (200) as claimed in claim 7, wherein the updated optimal route for the selected at least one energy supplier vehicle and for the energy consumer vehicle include energy exchange information, and wherein the energy exchange information includes amount of energy to be exchanged between the selected at least one energy supplier vehicle and energy consumer vehicle, time for energy exchange, and the energy exchange location.

10. The system (200) as claimed in claim 6, wherein the one or more processing unit (202) is further configured to:
identify, in real-time, a deviation in the updated optimal route of the at least one of the energy consumer vehicle and the selected at least one energy supplier vehicle; and
resequence the updated optimal route for the energy consumer vehicle, in response to identifying the deviation in the updated optimal route.
